(19) United States
(12) Patent Application Publication
(10) Pub. No.: US 2011/0045234 A1
(43) Pub. Date: Feb. 24, 2011

(54) METHOD AND CONFIGURATION FOR REINFORCING PLATE MATERIAL

(76) Inventors: Saburo Miyamoto, Kameyama-shi (JP); Yukitoshi Hase, Kameyama-shi (JP); Masayuki Yamamoto, Osaka (JP)

Correspondence Address: Cheng Law Group, PLLC, 1100 17th Street, N.W., Suite 503, Washington, DC, 20036, US

(21) Appl. No.: 12/834,450

(22) Filed: Jul. 12, 2010

(30) Foreign Application Priority Data
Aug. 18, 2009 (JP) 2009-189075

(51) Int. Cl. B32B 7/12; B32B 38/10

(52) U.S. Cl. 428/119; 156/265

(57) ABSTRACT

A joining roller rolls while pressing on a separator on a surface of a double-faced adhesive tape with through holes in rectangular shapes regularly formed therein in a longitudinal tape direction, and the double-faced adhesive tape is joined to a building panel. Thereafter, the separator is separated and the reinforcing member is joined to an adhesive layer of the double-faced adhesive tape while being pressed with the reinforcing member being kept parallel to the double-faced adhesive tape.

### BACKGROUND OF THE INVENTION

1. Field of the Invention

This invention relates to a method and configuration for reinforcing a plate material such as a panel including a building panel or a door and bonnet of an automobile.

2. Description of the Related Art

Building panels have been improved for upsizing and weight reduction. Specifically, the building panel tends to have a smaller thickness for realizing the weight reduction.

The panel material such as a building panel, however, has a reduced rigidity along with reduction in weight and thickness of the panel due to upsizing thereof. In order to overcome the reduced rigidity, a metallic reinforcing member is joined to the panel material via an adhesive or a double-faced adhesive tape to perform back reinforcement. See Japanese Patent Publication No. 2008-285993.

The conventional reinforcing method, however, has the following problems. That is, where an adhesive is used, uneven application of the adhesive to the reinforcing member may cause reduced adhesion thereof. Moreover, an excessive amount of the adhesive to be applied may lead to overflow from a joining surface of the reinforcing member. The overflowing adhesive contaminates the panel material or the members therearound. In addition, duration for drying the adhesive may be extended.

Use of a double-faced adhesive tape is effective in solving the foregoing problems. On the other hand, another problem may arise. That is, bubbles are to be caught between an adhesive layer of the adhesive tape and an adherend, which leads to reduced adhesion therebetween. The reduced adhesion may cause warps or damages in the panel material upon application of external forces.

### SUMMARY OF THE INVENTION

This invention provides a method and a configuration for reinforcing a plate material in which a reinforcing member may be adhered to the plate material via a double-faced adhesive tape with high accuracy.

Additional features of the invention will be set forth in the description which follows, and in part will be apparent from the description, or may be learned by practice of the invention.

This invention discloses a method for reinforcing a plate material to perform back reinforcement. The method includes the steps of forming a through hole in one of a surface of a double-faced adhesive tape as a joining member and a reinforcing member having ribs, and joining the member with the through hole to the member with no through hole and thereafter joining the reinforcing member or the plate material as an adherend to another surface of the double-faced adhesive tape.

According to this method for reinforcing the plate material, an adhesive layer of the double-faced adhesive tape with the through holes formed therein is joined to one adherend of the plate material and the reinforcing member, and thereafter another adhesive layer of the double-faced adhesive tape is joined to the other adherend. Here, the double-faced adhesive tape is joined to the adherend in advance, and may be joined thereto from one end to the other end thereof while a roller rolls and presses on the double-faced adhesive tape. Consequently, bubbles that tend to be caught on an interface between the adherend and the adhesive layer may be removed in a direction of joining the adhesive tape.

Where one adherend with the double-faced adhesive tape joined thereto is joined to the other adherend, both of the objects fail to be joined to each other while warping due to rigidity of the objects. Thus, a joining surface of the adherend later is to be joined to the double-faced adhesive tape while being pressed so as to be parallel to each other. Here, the double-faced adhesive tape with the through holes formed therein is smaller than that with no through hole in contact area of the adherend later and the double-faced adhesive tape per unit area. That is, a moving distance of the bubbles may be reduced that are caught on the interface for removal away with pressure of the adherend. Therefore, the bubbles may immediately be discharged outside the double-faced adhesive tape with through holes.

Catch of the bubbles may be suppressed on both adhesive interfaces of the plate material and the double-faced adhesive tape and of the reinforcing member and the double-faced adhesive tape, which results in improved adhesion of both objects to be joined.

In this method, the double-faced adhesive tape may have through holes that are continuously formed in series at given intervals in a longitudinal tape direction.

The through holes may also be formed in elongated shapes in the longitudinal tape direction.

In addition, small holes are preferably formed in a surface of the reinforcing member so as to correspond to the through holes in the double-faced adhesive tape.

In this method, the reinforcing member may be used in which through holes are formed in a tape joining surface between adjacent ribs.

According to this method, an adhesive layers of the double-faced adhesive tape is joined to one of the plate material and the reinforcing member with the through holes formed therein as one adherend, and thereafter the other adherend is joined to another adhesive layers of the double-faced adhesive tape. Here, the double-faced adhesive tape may be joined to the adherend with the double-faced adhesive tape joined thereto in advance from one end to the other end thereof while a roller rolls and presses on the double-faced adhesive tape. That is, bubbles that tend to be caught on an interface between the adherend and the adhesive layer may be removed in a direction of joining the adhesive tape.

It is more preferable to join the adhesive tape in advance to the plate material with the roller. The roller noted above may produce an effect to suppress catching of the bubbles on the adhesive interface between the panel material and the adhesive layer. Moreover, the roller may produce a further effect as follows. That is, the reinforcing member with the through holes formed therein is smaller than that with no through hole in contact area to the double-faced adhesive tape per unit area. That is, a moving distance of the bubbles may be reduced that are caught on the interface for removal away with pressure of the adherend. Therefore, the bubbles may immediately be discharged outside the double-faced adhesive tape with the through holes.

Catch of the bubbles may be suppressed on both the adhesive interfaces of the plate material and the double-faced adhesive tape and of the reinforcing member and double-faced adhesive tape, which results in improved adhesion of both objects to be joined. Here, the double-faced adhesive tape may be joined to the reinforcing member having the through holes formed therein, and thereafter the reinforcing member may be joined to the plate material.

In this method, the reinforcing member may have through holes that are continuously formed in series at given intervals in a longitudinal tape direction.

The through holes in the reinforcing member may also be formed in elongated shapes in the longitudinal direction.

This invention also discloses a configuration for reinforcing a plate material with back reinforcement. The configuration includes a double-faced adhesive tape with through holes formed therein via which the plate material is joined to a reinforcing member having ribs.

Herein, the double-faced adhesive tape may have through holes that are continuously formed in series at given intervals in a longitudinal tape direction.

The through holes in the double-faced adhesive tape may also be formed in elongated shapes in the longitudinal tape direction.

In addition, small holes are preferably formed in a surface of the reinforcing member so as to correspond to the through holes of the double-faced adhesive tape.

This invention also discloses a configuration for reinforcing a plate material with back reinforcement. Here, a reinforcing member has adjacent ribs and through holes on a tape joining surface between the ribs, and the reinforcing member is joined to the plate material via a double-faced adhesive tape.

Herein, the reinforcing member may have through holes that are continuously formed in series at given intervals in a longitudinal direction thereof.

The through holes in the reinforcing member may also be formed in elongated shapes in the longitudinal direction thereof.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is an exploded perspective view of a reinforcing configuration of a building panel according to Embodiment 1.

FIG. 2 is a partial schematic view in vertical section of the reinforcing configuration of the building panel according to Embodiment 1.

FIG. 3 is a perspective view of a double-faced adhesive tape according to Embodiment 1.

FIGS. 4 to 7 are diagrams each showing a method of reinforcing the building panel according to Embodiment 1.

FIG. 8 is a perspective view of a configuration for reinforcing a building panel according to Embodiment 2.

FIG. 9 is a partial schematic view in vertical section of the building panel according to Embodiment 2.

FIG. 10 is an exploded perspective view of a reinforcing configuration of a building panel according to one modification.

FIG. 11 is a perspective view of a reinforcing configuration of a building panel according to the modification.

FIG. 12 is a perspective view of a reinforcing configuration of a building panel according to another modification.

FIG. 13 is an exploded perspective view of a reinforcing configuration of a building panel according to another modification.

FIG. 14 is a partial schematic view in vertical section of the reinforcing configuration of the building panel according to the modification.

FIG. 15 is a partial schematic view in vertical section of a reinforcing configuration of a building panel according to another modification.

### DESCRIPTION OF THE PREFERRED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

One embodiment of this invention will be described hereunder with reference to the drawings.

In this exemplary embodiment, a method and configuration is to be described for reinforcing a building panel as a plate material with a reinforcing member. However, the method and configuration are not limited to this exemplary embodiment. For instance, the method and configuration are also applicable to a plate member, such as a door or bonnet of an automobile and a solar panel, that are required for reduction in thickness and weight.

### Embodiment 1

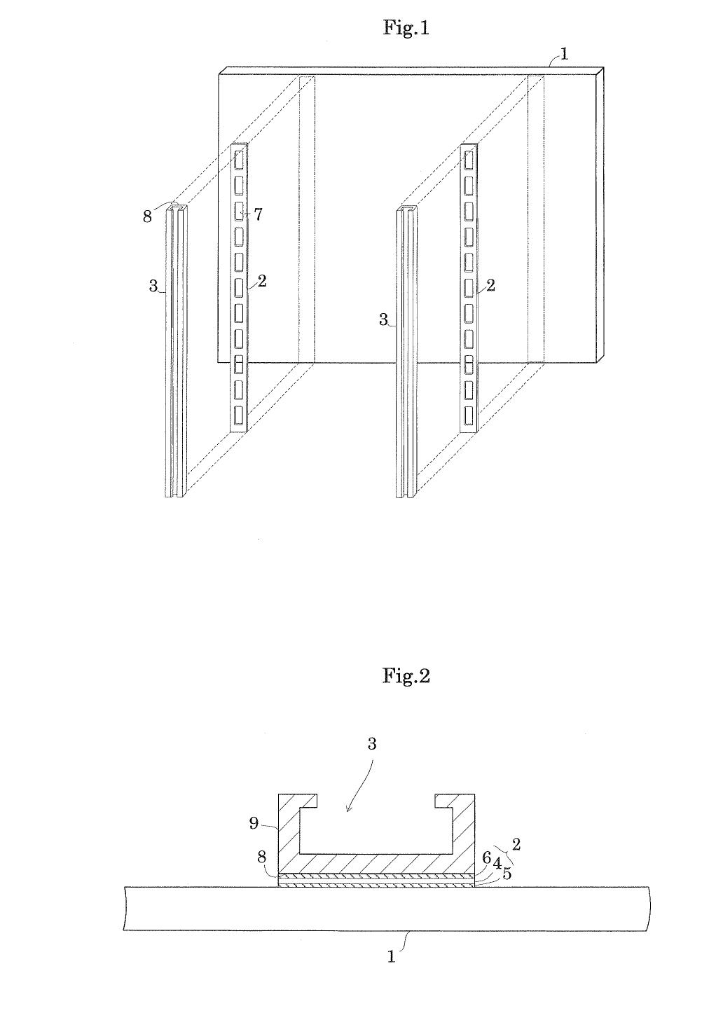

FIG. 1 is a perspective view on a rear side of a building panel on which back reinforcement is performed with a reinforcing member.

As shown in FIG. 1, the reinforcing configuration has reinforcing members 3 that are to be fixedly joined to a rear face of a building panel 1 via a double-faced adhesive tape 2.

Examples of the building panel 1 include a lightweight and large panel such as a ceramic board and a porous board.

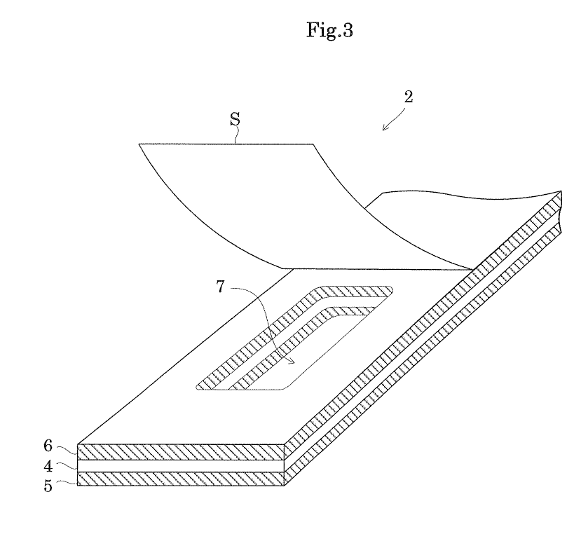

As shown in FIGS. 2 and 3, the double-faced adhesive tape 2 has adhesive layers 5 and 6 formed on opposite surfaces of a base material 4. A separator S is joined to a surface of the adhesive layer 6. Through holes 7 in rectangular shapes are formed in the double-faced adhesive tape 2 at given intervals in a longitudinal direction thereof.

Exemplary adhesives (pressure-sensitive adhesives) for constituting the adhesive layers 5 and 6 are not particularly limited, but known adhesives may be adopted such as such as acrylic adhesives, rubber adhesives, vinyl alkyl ether adhesives, silicone adhesives, polyester adhesives, polyamide adhesives, urethane adhesives, fluorine-containing adhesives, and epoxy adhesives. Among the foregoing adhesives, acrylic adhesives and/or rubber adhesives are preferable from the viewpoint of strong adhering properties. Acrylic adhesives are more preferable.

Exemplary rubber adhesives noted above include rubber adhesives containing, as base polymers, rubber components such as natural rubbers, styrene-isoprene-styrene block copolymers (SIS block copolymers), styrene-butadiene-styrene block copolymers (SBS block copolymers), styrene-ethylene/butylene-styrene block copolymers (SEBS block copolymers), styrene-butadiene rubbers, polybutadienes, polyisoprenes, polyisobutylenes, butyl rubbers (isobutylene-isoprene rubbers), chloroprene rubbers, silicone rubbers, acrylonitrile-butadiene rubbers, and ethylene-propylene terpolymers.

Exemplary acrylic adhesives include adhesives containing acrylic polymers, preferred are (meth)acrylic acid esters as monomer components, as base polymers (principal ingredients.) Alkyl(meth)acrylates ((meth)acrylic acid alkyl esters having linear or branched alkyl groups) may be preferably used as the main monomer components in acrylic polymers. Exemplary main monomer components in acrylic polymers include (meth)acrylic acid C₁₋₂₀ alkyl esters such as methyl(meth)acrylates, ethyl(meth)acrylates, propyl(meth)acrylates, isopropyl(meth)acrylates, butyl(meth)acrylates, isobutyl(meth)acrylates, s-butyl(meth)acrylates, t-butyl(meth)acrylates, pentyl(meth)acrylates, isopentyl(meth)acrylates, hexyl(meth)acrylates, heptyl(meth)acrylates, octyl(meth)acrylates, 2-ethylhexyl(meth)acrylates, isooctyl(meth)acrylates, nonyl(meth)acrylates, isononyl(meth)acrylates, decyl(meth)acrylates, isodecyl(meth)acrylates, undecyl(meth)acrylates, dodecyl(meth)acrylates, tridecyl(meth)acrylates, tetradecyl(meth)acrylates, pentadecyl(meth)acrylates, hexadecyl(meth)acrylates, heptadecyl(meth)acrylates, octadecyl(meth)acrylates, nonadecyl(meth)acrylates, and eicosyl(meth)acrylates. Among them, (meth)acrylic acid C₂₋₁₄ alkyl esters are preferred, and (meth)acrylic acid C₂₋₁₀ alkyl esters are more preferred. Herein, “(meth)acrylic acid esters” refers to “acrylic acid esters” and/or “methacrylic acid esters”, and the like.

Exemplary (meth)acrylic acid esters other than the alkyl(meth)acrylates include (meth)acrylic acid esters having alicyclic hydrocarbon groups, such as cyclopentyl(meth)acrylates, cyclohexyl(meth)acrylates, and isobornyl(meth)acrylates.

Each of the (meth)acrylic acid esters may be used alone or in combination. The amount of (meth)acrylic acid esters (preferably alkyl(meth)acrylates) is desirably 60 percent by weight or more, and more desirably 80 percent by weight or more, of the total amount of monomer components for the preparation of an acrylic polymer, because the (meth)acrylic acid esters are used as main monomer components of the acrylic polymer.

The acrylic polymer may further use, as monomer components, copolymerizable monomers of every kind, such as polar-group-containing monomers and multifunctional monomers. Copolymerizable monomers, if used as monomer components, help to improve adhesion to the adherend or to increase the cohesive strength of the adhesive. Each of different copolymerizable monomers can be used alone or in combination.

Exemplary polar-group-containing monomers include carboxyl-containing monomers such as (meth)acrylic acids, itaconic acid, maleic acid, fumaric acid, crotonic acid, and isocrotonic acid, and anhydrides of them, such as maleic anhydride; hydroxyl-containing monomers including hydroxyalkyl(meth)acrylates such as hydroxyethyl(meth)acrylates, hydroxypropyl(meth)acrylates, and hydroxybutyl(meth)acrylates; amido-containing monomers such as acrylamide, methacrylamide, N,N-dimethyl(meth)acrylamides, N-methylol(meth)acrylamides, N-methoxymethyl(meth)acrylamides, and N-butoxymethyl(meth)acrylamides; amino-containing monomers such as aminoethyl(meth)acrylates, dimethylaminoethyl(meth)acrylates, and t-butylaminoethyl(meth)acrylates; glycidyl-containing monomers such as glycidyl(meth)acrylates and methylglycidyl(meth)acrylates; cyano-containing monomers such as acrylonitrile and methacrylonitrile; heterocycle-containing vinyl monomers such as N-vinyl-2-pyrrolidone, (meth)acryloylmorpholines, N-vinylpyridine, N-vinylpiperidone, N-vinylpyrimidine, N-vinylpiperazine, N-vinylpyrrole, N-vinylimidazole, and N-vinyloxazole; alkoxyalkyl(meth)acrylate monomers such as methoxyethyl(meth)acrylates and ethoxyethyl(meth)acrylates; sulfonic-containing monomers such as sodium vinylsulfonate; phosphate-containing monomers such as 2-hydroxyethylacryloyl phosphate; imido-containing monomers such as cyclohexylmaleimide and isopropylmaleimide; and isocyanato-containing monomers such as 2-methacryloyloxyethyl isocyanate. Of these polar-group-containing monomers, preferred are carboxyl-containing monomers, such as acrylic acid, and anhydrides of them.

The amount of polar-group-containing monomers is, for example, 30 percent by weight or less (e.g., from 1 to 30 percent by weight), and preferably from 3 to 20 percent by weight, of the total amount of monomer components for the preparation of the acrylic polymer. Polar-group-containing monomers, if used in an amount of more than 30 percent by weight, may cause the acrylic pressure-sensitive adhesive to have an excessively high cohesive strength and to thereby have insufficient adhesion. Polar-group-containing monomers, if used in an excessively small amount (typically of less than 1 percent by weight of the total amount of monomer components for the preparation of the acrylic polymer), may cause no effect copolymerization of these monomers.

Exemplary multifunctional monomers include hexanediol di(meth)acrylates, butanediol di(meth)acrylates, (poly)ethylene glycol di(meth)acrylates, (poly)propylene glycol di(meth)acrylates, neopentyl glycol di(meth)acrylates, pentaerythritol di(meth)acrylates, pentaerythritol tri(meth)acrylates, dipentaerythritol hexa(meth)acrylates, trimethylolpropane tri(meth)acrylates, tetramethylolmethane tri(meth)acrylates, allyl(meth)acrylates, vinyl(meth)acrylates, divinylbenzene, epoxy acrylates, polyester acrylates, and urethane acrylates.

The amount of multifunctional monomers is, for example, 2 percent by weight or less (e.g., from 0.01 to 2 percent by weight), and preferably from 0.02 to 1 percent by weight, of the total amount of monomer components for the preparation of the acrylic polymer. Multifunctional monomers, if used in an amount of more than 2 percent by weight of the total amount of monomer components for the preparation of the acrylic polymer, may cause the adhesive to have an excessively high cohesive strength and to thereby have insufficient adhesion. Multifunctional monomers, if used in an excessively small amount (typically of less than 0.01 percent by weight of the total amount of monomer components for the preparation of the acrylic polymer) may cause no effect copolymerization of these monomers.

In addition to the polar-group-containing monomers and multifunctional monomers, exemplary usable copolymerizable monomers further include vinyl esters such as vinyl acetate and vinyl propionate; aromatic vinyl compounds such as styrene and vinyltoluene; olefins or dienes such as ethylene, butadiene, isoprene, and isobutylene; vinyl ethers such as vinyl alkyl ethers; and vinyl chloride.

The content of the base polymer (the acrylic polymer in the case of the acrylic adhesive) is not particularly limited, but is preferably 80 percent by weight or more, and more preferably from 85 to 95 percent by weight, of the total weight of the adhesive layer.

The adhesive layer may further contain suitable additives according to the purpose of use. Exemplary additives include crosslinking agents corresponding to the type of the base polymers, such as polyisocyanate crosslinking agents, silicone crosslinking agents, epoxy crosslinking agents, and alkyl-etherified melamine crosslinking agents; tackifiers including tackifiers that are solid, semisolid, or liquid at ambient temperature (room temperature) and are made from materials such as rosin derivative resins, polyterpene resins, petroleum resins, and oil-soluble phenolic resins; plasticizers; modifiers (e.g., lauryl mercaptan, thioglycolic acid); fillers; age inhibitors (e.g., antioxidants, ultraviolet absorbers, light stabilizers); colorants e.g., pigments, dyestuffs.) Moreover, when the adhesive contains bubbles and/or hollow microspheres mentioned later, fluorine-containing surfactants are preferably contained as additives. The incorporation of the additives is not particularly limited, but is preferably 50 parts by weight or less, more preferably 10 parts by weight or less, per 100 parts by weight monomers all for constitution of the base polymer (e.g., all the monomer components for constituting the acrylic polymer.)

Curing reaction by heat or active energy beams using polymerization initiators (such as thermal polymerization initiators and photopolymerization initiators (photoinitiators)) may be adopted in the preparation of the acrylic polymer as the base polymer. Curing reaction (photopolymerization) by heat or active energy beams using photopolymerization initiators may be preferably adopted from the viewpoint of reduction in polymerization period of time and bubble stability upon incorporation of bubbles. Each of different photopolymerization initiators may be used alone or in combination.

Examples of thermal polymerization initiators include azo thermal polymerization initiators such as 2,2′-azobisisobutyronitrile, 2,2′-azobis-2-methylbutyronitrile, dimethyl 2,2′-azobis(2-methylpropionate), 4,4′-azobis-4-cyanovaleric acid, azobisisovaleronitrile, 2,2′-azobis(2-amidinopropane) dihydrochloride, 2,2′-azobis[2-(5-methyl-2-imidazolin-2-yl)propane]dihydrochloride, 2,2′-azobis(2-methylpropionamidine) disulfate, and 2,2′-azobis(N,N′-dimethyleneisobutylamidine) dihydrochloride; peroxide thermal polymerization initiators such as dibenzoyl peroxide and tert-butyl permaleate; and redox thermal polymerization initiators. The amount of the thermal polymerization initiators is not particularly limited, but may be in a range used for a conventional thermal polymerization initiator.

The photopolymerization initiator as described above is not particularly limited. Examples of the photopolymerization initiator include a benzoin ether-based photopolymerization initiator, an acetophenone-based photopolymerization initiator, an □-ketol-based photopolymerization initiator, an aromatic sulfonyl chloride-based photopolymerization initiator, a photo active oxime-based photopolymerization initiator, a benzoin-based photopolymerization initiator, a benzyl-based photopolymerization initiator, a benzophenone-based photopolymerization initiator, a ketal-based photopolymerization initiator or a thioxanthone-based photopolymerization initiator.

Specifically, examples of the benzoin ether-based photopolymerization initiator include benzoin methyl ether, benzoin ethyl ether, benzoin propyl ether, benzoin isopropyl ether, benzoin isobutyl ether, 2,2-dimethoxy-1,2-diphenylethan-1-one and anisole methyl ether Examples of the acetophenone-based photopolymerization initiator include 2,2-diethoxyacetophenone, 2,2-dimethoxy-2-phenylacetophenone, 1-hydroxycyclohexyl phenyl ketone, 4-phenoxydichloroacetophenone and 4-(t-butyl)-dichloroacetophenone. Examples of the □-ketol-based photopolymerization initiator include 2-methyl-2-hydroxypropiophenone and 1-(4-(2-hydroxyethyl)-phenyl)-2-methylpropan-1-one. Examples of the aromatic sulfonyl chloride-based photopolymerization initiator include 2-naphthalenesulfonyl chloride. Examples of the photo active oxime-based photopolymerization initiator include 1-phenyl-1,1-propanedion-2-(o-ethoxycarbonyl)-oxime.

Examples of the benzoin-based photopolymerization initiator include benzoin. Examples of the benzyl-based photopolymerization initiator include benzyl. Examples of the benzophenone-based photopolymerization initiator include benzophenone, benzoyl benzoic acid, 3,3′-dimethyl-4-methoxybenzophenone, polyvinyl benzophenone and □-hydroxycyclohexyl phenyl ketone. Examples of the ketal-based photopolymerization initiator include benzyl dimethyl ketal. Examples of the thioxanthone-based photopolymerization initiator include thioxanthone, 2-chlorothioxanthone, 2-methylthioxanthone, 2,4-dimethylthioxanthone, isopropylthioxanthone, 2,4-diisopropylthioxanthone, and dodecylthioxanthone.

The amount of the photopolymerization initiator is not particularly limited. For example, it may be used in an amount selected from the range of 0.01 to 5 part by weight (preferably 00.5 to 3 parts by weight) based on 100 parts by weight of the total monomer components for constituting the base polymer in the adhesive (for example total monomer components constituting the acrylic polymer.)

In activating the photopolymerization initiator, it is important to irradiate the adhesive composition with active energy beams. Examples of the active energy beams include ionizing radiations such as □-rays, □-rays, □-rays, neutron rays and electron rays and ultraviolet light. Of these, ultraviolet light is preferable. The irradiation energy, irradiation time, etc. of the active energy beams are not particularly limited so long as the photopolymerization initiator may be activated to generate the monomer components.

An adhesive layer in the adhesive sheet for use herein is preferably an adhesive layer formed of adhesives containing bubbles and/or hollow microspheres. Containing of at least one of such bubbles and/or hollow microspheres may help the adhesive layer to follow the curved surface, step or unevenness more satisfactorily, which results in improved adhesive properties. Hereinafter, an adhesive (adhesive layer) containing bubbles and/or hollow microspheres may also be generally referred to as a “bubble-containing adhesive (adhesive layer).”

The amount of bubbles to be contained in the adhesive composition is not particularly limited and may be set within ranges not adversely affecting, for example, adhesive properties. The amount of bubbles is typically in a range of 5 to 10 percent by volume, preferably of 10 to 40 percent by volume, and more preferably of 12 to 30 percent by volume. The amount of bubbles less than 5 percent by volume may cause hard stress relaxation, which may lead to reduced step absorbency and adhesive properties. On the other hand, the amount of bubbles more than 50 percent by volume may cause bubbles to pass through the adhesive layers, which may lead to reduced adhesive properties and excessive soft bubble-containing adhesive layers.

The bubbles to be contained in the adhesive layers are basically preferably closed cells, but they may be a mixture of closed cells and open cells.

Such bubbles generally have spherical shapes, but may have distorted spheroidal shapes. The average diameter of the bubbles is not particularly limited, but may be, for example, from 1 to 1000 □m, preferably from 10 to 500 □m, and more preferably from 30 to 300 □m.

Exemplary gaseous components to be contained in the bubbles (gas component constituting bubbles; hereinafter also referred to as a “bubble-constituting gas”) include, but are not limited to, gaseous components of every kind, including inert gases such as nitrogen, carbon dioxide, and argon gases, and air. It is important that, when a reaction such as polymerization reaction is carried out after incorporating a bubble-constituting gas into a pressure-sensitive adhesive composition, a bubble-constituting gas not adversely affecting the reaction should be chosen. Of such bubble-constituting gases, nitrogen gas is preferred, typically because it does not adversely affect reactions and is inexpensively available.

Use of the hollow microspheres as one component of the bubble-containing adhesive layers may improve step absorbency, shearing adhesive force, and workability. Each of different hollow microspheres may be used alone or in combination.

The hollow microspheres may be hollow inorganic microspheres or hollow organic microspheres. Of such hollow microspheres, exemplary hollow inorganic microspheres include hollow balloons made of glass, such as hollow glass balloons; hollow balloons made of metallic compounds, such as hollow alumina balloons; and hollow balloons made of ceramics, such as hollow ceramic balloons. Exemplary hollow organic microspheres include hollow balloons made from resins, such as hollow acrylic balloons and hollow polyvinylidene chloride balloons.

The particle diameter (average particle diameter) of the hollow microspheres is not particularly limited, but can be selected within ranges typically of from 1 to 500 □m, preferably from 5 to 200 □m, and more preferably from 10 to 100 □m.

The specific gravity of the hollow microspheres is not particularly limited but can be selected within ranges typically of from 0.1 to 0.8 g/cm³, and preferably from 0.12 to 0.5 g/cm³. Hollow microspheres, if having a specific gravity of less than 0.1 g/cm³, are difficult to be dispersed in an adhesive composition, because such hollow microspheres tend to float upon the composition during mixing. In contrast, hollow microspheres, if having a specific gravity of more than 0.8 g/cm³, may be expensive to increase the production cost.

The amount of hollow microspheres is not particularly limited and can be selected within such ranges that hollow microspheres occupy, for example, 5 to 50 percent by volume, preferably 10 to 50 percent by volume, and more preferably 15 to 40 percent by volume, of the total volume of the adhesive layer. Hollow microspheres, if occupying less than 5 percent by volume, may not sufficiently exhibit their advantages. In contrast, hollow microspheres, if occupying more than 50 percent by volume, may cause the adhesive layer to have insufficient adhesion.

A adhesive layer composition for constituting the adhesive layer used herein (including the bubble-containing adhesive layer) may be prepared by mixing components such as monomer components constituting the base polymer (e.g., (meth)acrylic acid esters), a polymerization initiator, and additives according to a known procedure. Where necessary typically for the modification of viscosity, the monomer components may be partially polymerized. Specifically, in the case of photopolymerization, the pressure-sensitive adhesive composition may be prepared, for example, according to the following process. (i) Monomer components for constituting the base polymer (e.g., (meth)acrylic acid esters or other copolymerizable monomers) are mixed with a polymerization initiator to give a monomer mixture, and (ii) a photopolymerization reaction corresponding to the type of the photopolymerization initiator (for example, polymerization through ultraviolet irradiation) is carried out on the monomer mixture to give a composition (syrup) only part of whose monomer components are polymerized. Next, (iii) the syrup is combined with hollow microspheres, fluorine-containing surfactants, and other additives according to necessity. Further, (iv) bubbles are incorporated into the composition obtained in the step (iii) when bubbles are to be contained in the adhesive layer. The way to prepare the bubble-containing adhesive composition is, however, not limited to this process. In preparing the syrup, the way may be adopted, for example, to mix hollow microspheres or fluorine-containing surfactants in the monomer mixture in advance.

Bubbles, if to be contained in the adhesive layer, is preferably incorporated as a last component into the adhesive composition as in the above preparation process, so as help the bubbles to mix with the adhesive layer satisfactorily and to be stably contained therein. The precursor composition before incorporation of bubbles (e.g., the composition obtained in the step (iii)) preferably has a higher viscosity so as to contain bubbles stably. The viscosity of the precursor composition before incorporation of bubbles is not particularly limited, but is, for example, preferably from 5 to 50 Pa·s, and more preferably from 10 to 40 Pa·s, as measured with a BH type viscometer using a No. 5 rotor at a number of revolutions of 10 rpm and at a temperature of 30° C. A precursor composition, if having an excessively low viscosity of less than 5 Pa·s, may not satisfactorily bear bubbles, because incorporated bubbles can immediately coalesce to escape out of the system. In contrast, a precursor composition, if having an excessively high viscosity of more than 50 Pa·s, may be difficult to form an adhesive layer by coating. The viscosity of the precursor composition can be adjusted typically by incorporating polymer components such as acrylic rubbers and thickening additives thereinto; or by partially polymerizing monomer components for constituting the base polymer.

In preparing the bubble-containing adhesive composition, the way to incorporate bubbles into the precursor composition is not particularly limited, and a known technique for mixing or blending bubbles into such compositions may be employed. An exemplary device for use herein is one that includes a disc having a through hole at the center part, a stator having a multiplicity of fine teeth and arranged on the disc, and a rotor facing the stator, having a multiplicity of fine teeth, and arranged on the disc. Using this device, the precursor composition is introduced in between the teeth of the stator and the teeth of the rotor, and a gaseous component for constituting bubbles (bubble-constituting gas) is introduced via the through hole into the precursor composition while rotating the rotor at high speed, to allow the bubble-constituting gas to be finely divided and dispersed in the precursor composition, to give a bubble-containing adhesive composition containing finely dispersed bubbles.

To suppress or prevent coalescence of bubbles, it is desirable to carry out the steps from the incorporation of bubbles to the formation of the pressure-sensitive adhesive layer as a series of steps. Specifically, it is desirable that an adhesive composition is prepared by mixing bubbles thereinto in the above way, and the adhesive composition is immediately subjected to the formation of the adhesive layer.

The thickness of the adhesive layer for use herein is not particularly limited, but is preferably from 50 to 5000 □m, more preferably from 200 to 2000 □m, and further more preferably from 300 to 1200 □m. The adhesive layer having a thickness of less than 50 □m may cause reduced cushioning properties and adhesive properties of the adhesive sheet to the steps. In contrast, the adhesive layer having a thickness of more than 5000 □m may cause difficulties in realizing the adhesive layer or sheet of a uniform thickness. The adhesive layer may have a single-layer structure or multilayer structure.

A conventional release paper may be adopted as the separator S noted above. For instance, a substrate having a releasing treated layer which is treated with a releasing agent at least one surface; a low adhesive substrate made of a fluorinated polymer (for example, polytetrafluoroethylene, polychlorotrifluoroethylene, polyvinyl fluoride, polyvinylidene fluoride, tetrafluoroethylene-hexafluoropropylene copolymer or chlorofluoroethylene-vinylidene fluoride copolymer); or a low adhesive substrate made of a non-polar polymer (for example, an olefin-based resin such as polyethylene or polypropylene).

As the separator S, it is preferable to use, for example, a separator having a releasing treated layer on at least one surface of a separator substrate. Examples of such a separator substrate include: plastic-based films (synthetic resin films) such as a polyester film (a polyethylene terephthalate film and the like), an olefin-based resin film (a polyethylene film, a polypropylene film and the like), a polyvinyl chloride film, a polyimide film, a polyamide film (a nylon film) and a rayon film; papers (woodfree paper, Japanese paper, craft paper, glassine paper, synthetic paper, topcoat paper, etc.); and multilayered materials (two- or three-layered complexes) produced by laminating or co-extruding these materials. The releasing agent forming the releasing treated layer is not particularly limited. The releasing agent may be used such as a silicone-based releasing agent, a fluorinated releasing agent, and a long-chain alkyl-based releasing agent. These releasing agents may be used alone or in combination thereof.

The reinforcing member 3 has two ribs 9 erected on opposite ends across a joining surface 8 in a width direction.

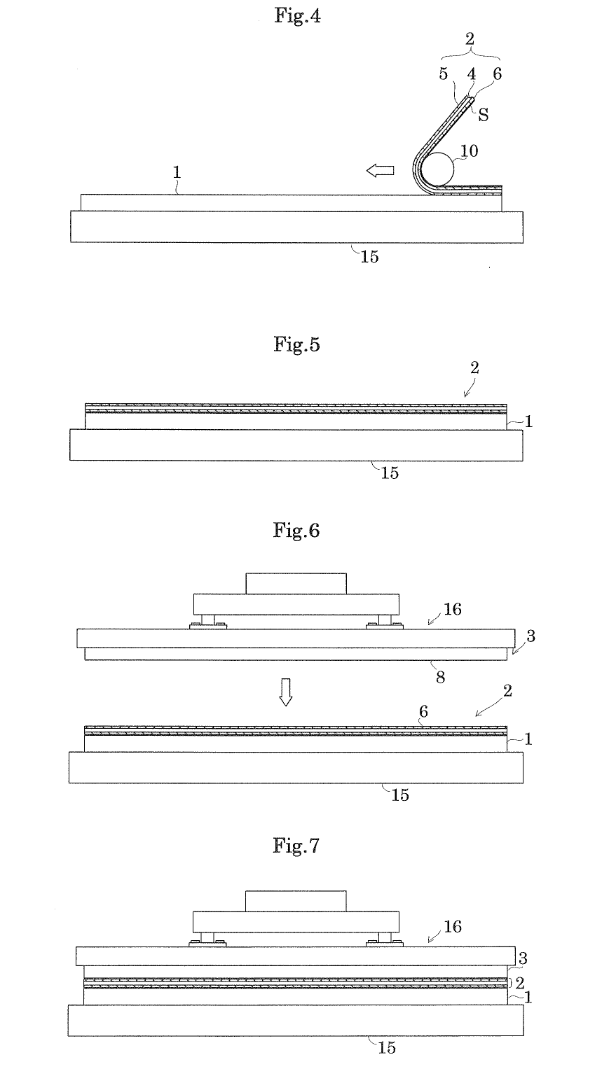

Next, a method for reinforcing a building panel 1 having the foregoing configuration will be described with reference to FIGS. 4 to 7.

As shown in FIG. 4, a joining roller 10 rolls while pressing on a separator S on a surface of the double-faced adhesive tape 2 that is supplied from a wound original master roll. The double-faced adhesive tape 2 is joined to a rear face of the building panel 1 on a mount table 15 from one end to the other end thereof.

Upon completion of joining the double-faced adhesive tape 2, the separator S is separated as shown in FIG. 5. In FIG. 6, a pressing mechanism 16 holds a reinforcing member 3 such that a joining surface 8 of the reinforcing member 3 is disposed above an exposed adhesive layer 6 parallel to each other with the separator S separated therefrom. Subsequently, at least one of the building panel 1 and the reinforcing member 3 moves vertically so as to approach relatively while keeping parallel to each other. Consequently, as shown in FIG. 7, the reinforcing member 3 is joined to the building panel 1 via the double-faced adhesive tape 2.

As described above, back reinforcement to the building panel 1 as a plate material is completed using the reinforcing member 3.

According to the foregoing reinforcing method, the joining roller 10 firstly rolls while pressing on the double-faced adhesive tape 2 from one end to the other end of the building panel 1 as a plate material. Consequently, bubbles that tend to be caught on an interface between the panel and the adhesive tape may be removed in a direction where the joining roller 10 rolls.

The double-faced adhesive tape 2 joined to the building panel 1 has through holes 7 in rectangular shapes formed at given intervals in a longitudinal direction thereof. Thus, the double-faced adhesive tape with the through holes formed therein is smaller than that with no through hole formed therein in contact area of the adhesive layer 6 and the reinforcing member 3 per unit area. That is, a distance for discharging the bubbles caught on the interface between the reinforcing member 3 and the adhesive layer 6 is reduced. Therefore, the bubbles caught on the interface may immediately be discharged outside in a width direction of the reinforcing member 3 into the through holes 7 with pressure of the reinforcing member 3.

Catch of the bubbles may be suppressed on both interfaces of the double-faced adhesive tape 2, which results in improved adhesion of the building panel 1 and the reinforcing member 3. Consequently, the reinforcing member 3 may be prevented from dropping off due to reduced adhesion.

A small amount of bubbles are discharged into the through holes 7 formed in the double-faced adhesive tape 2, and thus the through holes 7 closed with the building panel 1 and the reinforcing member 3 is not expansively deformed.

### Embodiment 2

Embodiment 2 differs from Embodiment 1 in configuration of the double-faced adhesive tape and the reinforcing member. Here, a configuration will be described in which back reinforcement is performed on the building panel 1 via a double-faced adhesive tape with no through hole formed therein using a reinforcing member with through holes formed therein. Here, same reference numerals are to be used to identify same elements as in Embodiment 1, and merely different elements from Embodiment 1 are to be described in detail.

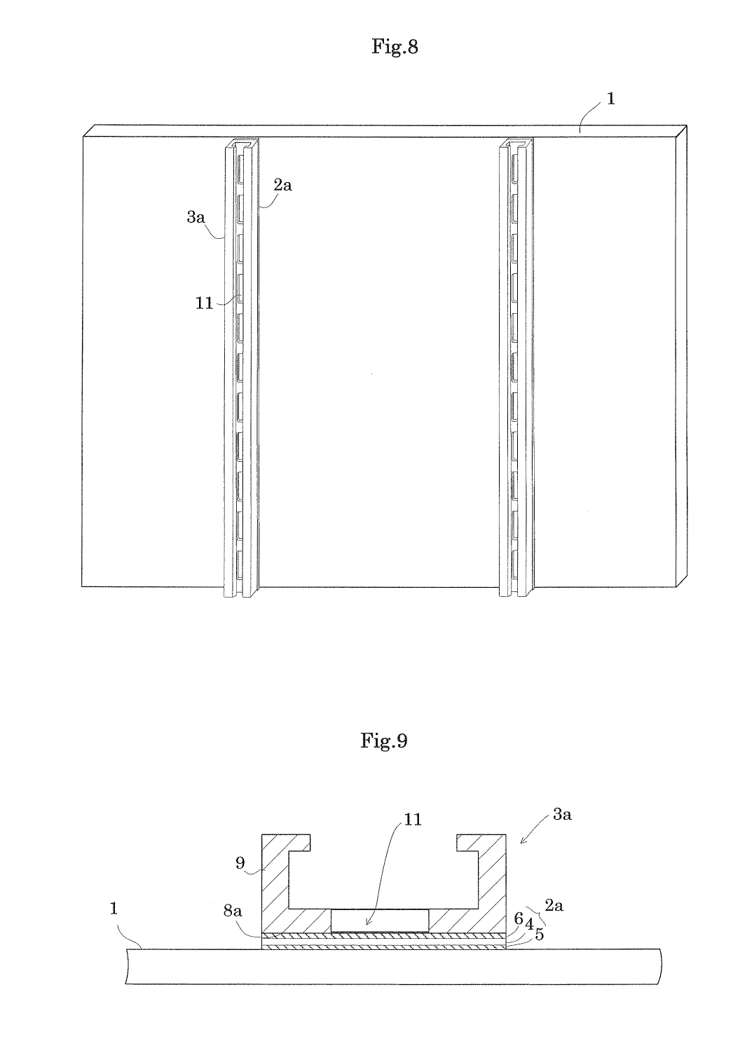

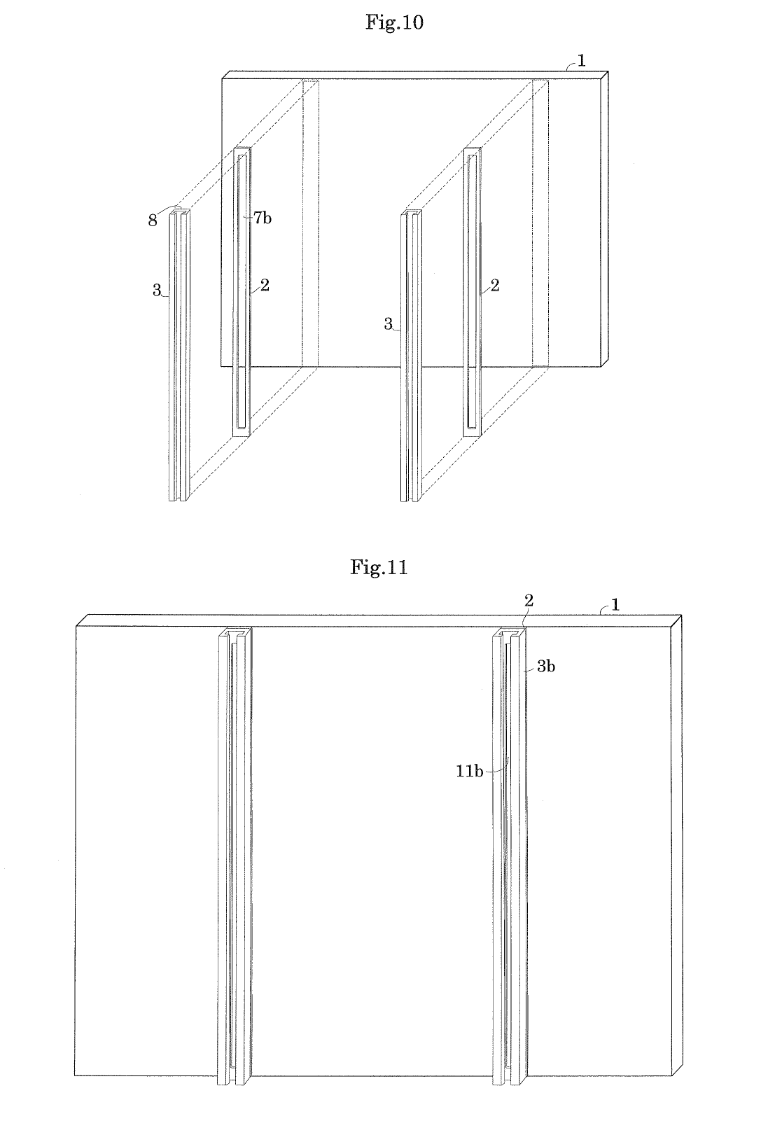

As shown in FIGS. 8 and 9, the reinforcing configuration has a reinforcing member 3a fixedly joined to a rear face of a building panel 1 via a double-faced adhesive tape 2a.

The double-faced adhesive tape 2a of a strip shape has adhesive layers 5 and 6 on opposite surfaces of a base material 4. The adhesive layer 6 has a separator joined to the surface thereof.

The reinforcing member 3a has two ribs 9 erected on opposite ends across a joining surface 8a in a width direction. The reinforcing member 3a has through holes 11 in rectangular shapes formed between the ribs 9 in a longitudinal direction of the joining surface 8a.

The reinforcing configuration in Embodiment 2 may be realized by the same procedure as in Embodiment 1.

That is, the joining roller 10 shown in FIG. 4 firstly rolls to join the double-faced adhesive tape 2a to a rear face of the building panel 1. Thereafter, a separator S is separated. Next, the joining surface 8a of the reinforcing member 3a is disposed above an exposed adhesive layer 6 so as to be parallel to each other. Subsequently, the reinforcing member 3a is pressed to join to the adhesive layer 6 while keeping parallel to each other.

As described above, the reinforcing configuration in Embodiment 2 is completed.

According to the foregoing reinforcing method, the joining roller 10 firstly rolls while pressing on the double-faced adhesive tape 2a from one end to the other end of the building panel 1 as a plate material. Consequently, bubbles that tend to be caught on an interface between the panel and the adhesive tape may be removed in a direction where the joining roller 10 rolls.

The reinforcing member 3a joined to the building panel 1 has through holes in rectangular shapes formed regularly at given intervals in a longitudinal direction. Thus, the reinforcing member 3a with the through holes 11 formed therein is smaller than the reinforcing member 3 with no through hole 11 formed therein in contact area of the adhesive layer 6 and the reinforcing member 3a per unit area. That is, a distance for discharging the bubbles caught on the interface between the reinforcing member 3a and the adhesive layer 6 is reduced. Therefore, the bubbles caught on the interface may immediately be discharged outside in a width direction of the reinforcing member 3a and into the through holes 11 with pressure of the reinforcing member 3a.

Catch of the bubbles may be suppressed on both interfaces of the double-faced adhesive tape 2a, which results in improved adhesion of the building panel 1 and the reinforcing member 3a. Consequently, the reinforcing member 3a may be prevented from dropping off.

This invention is not limited to the foregoing embodiment, but may be modified as follows.

In Embodiment 1, the shape of the through hole 7 formed in the double adhesive tape 2 is not limited to a rectangular shape. As shown in FIG. 10, a through hole 7b may be formed in an elongated shape in the longitudinal direction of the adhesive tape 2. A length of the through hole 7b in the elongated shape is variable as appropriate in accordance with adhesive strength given to the building panel 1. Accordingly, two or more through holes 7b in the elongated shapes may be formed in the longitudinal direction of the adhesive tape 2.

In Embodiment 2, the shape of the through hole 11 formed in the reinforcing member 3a is not limited to a rectangular shape. As shown in FIG. 11, a through hole 11b may be formed in an elongated shape in the longitudinal direction of the reinforcing member 3b. A length of the through hole 11b in the elongated shape is variable as appropriate in accordance with adhesive strength given to the building panel 1. Accordingly, two or more through holes 11b in the elongated shapes may be formed in the longitudinal direction of reinforcing member 3b.

In Embodiment 2, the reinforcing member 3a with the double-faced adhesive tape 2a joined thereto in advance may be joined to the building panel 1.

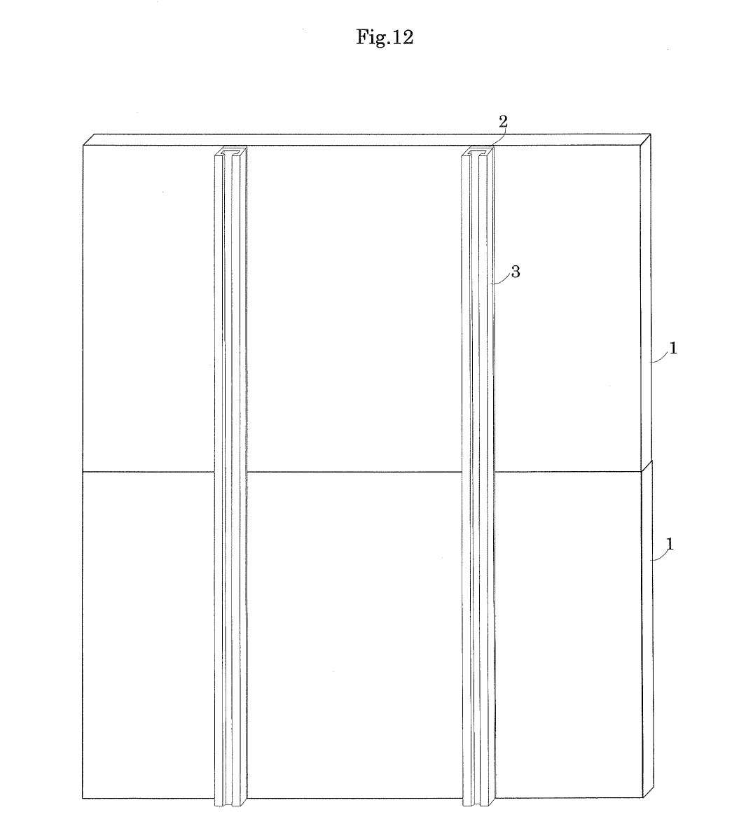

In each foregoing embodiments, back reinforcement may be performed on two or more building panels 1 with the reinforcing members 3, as shown in FIG. 12. Here, the double-faced adhesive tape 2 has two or more through holes 7 formed in rectangular shapes in the longitudinal direction of the adhesive tape, which is similar to that in Embodiment 1. In other embodiments, back reinforcement may be performed on two or more building panels 1 with the reinforcing members 3.

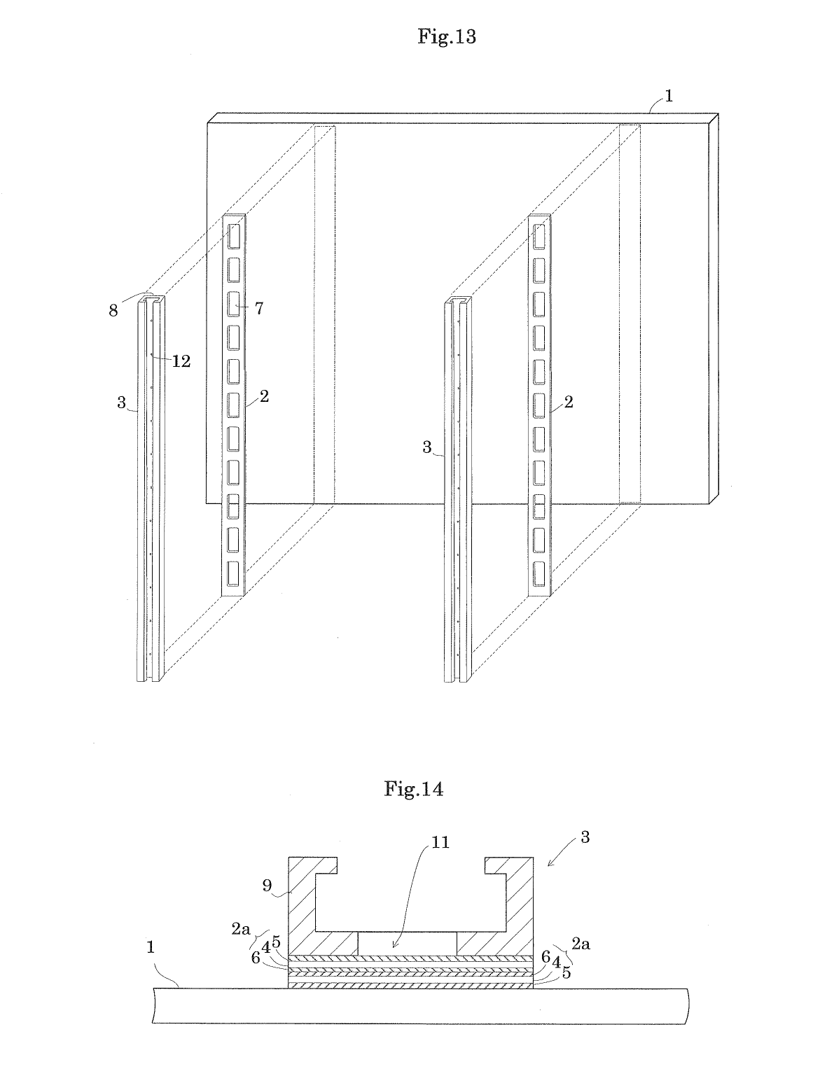

As shown in FIG. 13, in the reinforcing configuration in which the double-faced adhesive tape 2 in Embodiments 1 and 2 has through holes 7 and 7a formed therein, respectively, the reinforcing member 3 having through holes 12 of several millimeters may be joined to the joining surface 8 that faces to the through holes 7 and 7a. Here, when the building panel 1 is a fireproof board, and the double-faced adhesive tape 2 has heat resistance, the through holes 12 may prevent air inside the through holes 7 and 7a from expanding even in the case of heating the air. Consequently, unnecessary separation force applied on the adhesive interfaces may be suppressed.

In the reinforcing method in each embodiment mentioned above, the building panel 1 may be housed in a chamber, and the double-faced adhesive tape 2 may be joined within the chamber while removing air inside. Similarly, the building panel 1 with the double-faced adhesive tape 2 joined thereto may be housed within the chamber for joining the reinforcing member 3 thereto.

In this method, the chamber with the building panel 1 housed therein is to be used for joining the double-faced adhesive tape 2 to the building panel 1. When the reinforcing member 3 is joined to the building panel 1 with the double-faced adhesive tape 2 joined thereto, a cover is to be used that has a length and width to house the reinforcing member 3 and is capable of adhering to the building panel 1 firmly.

According to this method, more accurate removal of the bubbles may be realized from both the adhesive interfaces, i.e., the interface between the building panel 1 and the double-faced adhesive tape 2 and that between the reinforcing member 3 and the double-faced adhesive tape 2.

In each embodiment mentioned above in which the double-faced adhesive tape 2 having the through holes 7 and 7b formed therein is joined to the objects to be joined 1 and 3, respectively, the double-faced adhesive tape 2 is firstly joined to the building panel 1, and thereafter to the reinforcing member 3. The following method may also be adopted for reinforcing the building panel 1.

That is, the method may be adopted of joining the double-faced adhesive tape 2 to the reinforcing member 3 with the joining roller 10, and thereafter joining the reinforcing member 3 to the building panel 1, thereby producing the same effect as in each foregoing embodiments.

In Embodiment 2, one double-faced adhesive tape 2 is joined to one of the objects to be joined 1 and 3, and thereafter to the other of the objects to be joined 1 and 3. Moreover, two double-faced adhesive tapes 2 may be adopted.

The joining roller 10 joins the double-faced adhesive tapes 2a with no through hole formed therein to each of the building panel 1 and the reinforcing member 3 with the through holes formed therein, and separates the separator S from the double-faced adhesive tapes 2a. Subsequently, the exposed adhesive layers 5 and 6 of the double-faced adhesive tapes 2a having the objects to be joined 1 and 3 joined thereto are disposed parallel to each other. Next, the double-faced adhesive layer 5 is joined to the adhesive layer 6, as shown in FIG. 14.

According to the reinforcing configuration in which the reinforcing member 3 is joined by the foregoing reinforcing method, catch of the bubbles may be suppressed on the interfaces by rolling of the joining roller 10 during joining of the double-faced adhesive tapes 2a to the objects to be joined 1 and 3. Consequently improved adhesion of the objects to be joined 1 and 3 may be realized.

It is hard to eliminate bubbles during joining of the double-faced adhesive tapes. Here, adhering of the adhesive layers may lead to increased adhesive strength.

In each of the foregoing embodiments, the reinforcing member 3 is joined to the building panel 1 via one double-faced adhesive tape 2 of the same width as the reinforcing member 3. The following configuration may also be used.

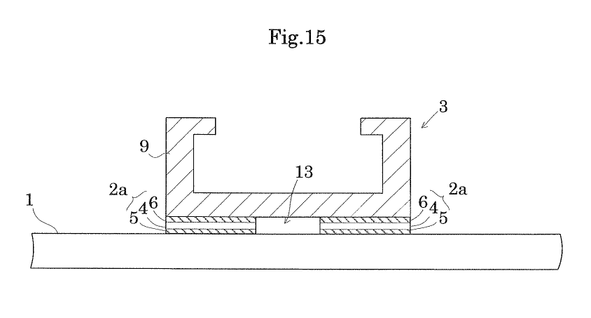

That is, the reinforcing member may be joined to the building panel 1 via two or more double-faced adhesive tapes 2a of a width smaller than the reinforcing member 3 with no through holes formed therein. As shown in FIG. 15, two double adhesive tapes 2a are joined to the reinforcing member 3 so as to keep side edges thereof aligned. Moreover, a space 13 is provided for preventing inner edges of the double-faced adhesive tapes 2a from contacting each other. In this configuration, the space 13 has the same function as the through holes 7 and 7b.

In the double-faced adhesive tape 2 and the reinforcing member 3 in each of the foregoing embodiments, the through holes may have rectangular or elongated shapes. With this configuration a uniform contact width of the building panel 1 or reinforcing member 3 and the double-faced adhesive tape 2 may be realized. Consequently, distances for discharging the bubbles may be uniform. Here, the shape of the through hole is not limited to a rectangular shape. The shape of the through hole is variable as appropriate depending on the shape of the reinforcing member 3. For example, a circular or oval shape may be adopted.

In each reinforcing method in the foregoing embodiments, a heater may be embedded within at least one of the mount table 15 and pressing mechanism 16 for joining the double-faced adhesive tape 2 while heating.

According to the reinforcing method, the adhesive layers 5 and 6 may be joined to the objects to be joined 1 and 3 while being softened, which results in increased efficiency in discharging the bubbles.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method of reinforcing a plate material with back reinforcement, comprising the steps of:
forming a through hole in one of a surface of a double-faced adhesive tape as a joining member and a reinforcing member having ribs; and
joining the member with the through hole to the member with no through hole and thereafter joining the reinforcing member or the plate material as an adherend to another surface of the double-faced adhesive tape.

2. The method of reinforcing the plate material according to claim 1, wherein
the double-faced adhesive tape has through holes that are continuously formed in series at given intervals in a longitudinal tape direction.

3. The method of reinforcing the plate material according to claim 1, wherein
the through holes are formed in elongated shapes in the longitudinal tape direction.

4. The method of reinforcing the plate material according to claim 1, wherein
small holes are formed in a surface of the reinforcing member so as to correspond to the through holes in the double-faced adhesive tape.

5. The method of reinforcing the plate material according to claim 1, wherein
the reinforcing member has through holes formed therein in a tape joining surface between adjacent ribs.

6. The method of reinforcing the plate material according to claim 5, wherein
the through holes in the reinforcing member are continuously formed in series at given intervals in a longitudinal tape direction.

7. The method of reinforcing the plate material according to claim 5, wherein
the through holes in the reinforcing member are formed in elongated shapes in the longitudinal tape direction.

8. The method of reinforcing the plate material according to claim 1, wherein
the double-faced adhesive tape is joined to the reinforcing member and the plate material within a chamber under a reduced pressure.

9. A configuration for reinforcing a plate material with back reinforcement, comprising:
a double-faced adhesive tape with through holes formed therein via which the plate material is joined to a reinforcing member having ribs.

10. The configuration for reinforcing the plate material according to claim 9, wherein
the double-faced adhesive tape has through holes that are continuously formed in series at given intervals in a longitudinal tape direction.

11. The configuration for reinforcing the plate material according to claim 9, wherein
the through holes in the double-faced adhesive tape are formed in elongated shapes in the longitudinal tape direction.

12. The configuration for reinforcing the plate material according to claim 9, wherein
small holes are formed in a surface of the reinforcing member so as to correspond to the through holes of the double-faced adhesive tape.

13. A configuration for reinforcing a plate material with back reinforcement, comprising:
a reinforcing member having adjacent ribs; and
through holes on a tape joining surface between the ribs;
the reinforcing member being joined to the plate material via a double-faced adhesive tape.

14. The configuration for reinforcing the plate material according to claim 13, wherein
the reinforcing member has through holes that are continuously formed in series at given intervals in a longitudinal direction thereof.

15. The configuration for reinforcing the plate material according to claim 13, wherein
the through holes in the reinforcing member are formed in elongated shapes in the longitudinal direction thereof.
